(19) United States
(12) Patent Application Publication
(10) Pub. No.: US 2026/0362459 A1
(43) Pub. Date: Nov. 12, 2026

(54) UPLINK POWER CONTROL BASED ON ON-DEMAND SSB

(71) Applicant: Samsung Electronics Co., Ltd., Suwon-si (KR)

(72) Inventors: Hongbo Si, Allen, TX (US); Aristides Papasakellariou, Houston, TX (US)

(21) Appl. No.: 19/639,026

(22) Filed: Apr. 3, 2026

Related U.S. Application Data
(60) Provisional application No. 63/801,449, filed on May 7, 2025.
(60) Provisional application No. 63/863,063, filed on Aug. 13, 2025.
(60) Provisional application No. 63/906,803, filed on Oct. 28, 2025.
(60) Provisional application No. 63/929,295, filed on Dec. 2, 2025.

(51) Int. Cl. H04W 72/30; H04B 7/06; H04W 52/14

(52) U.S. Cl. CPC H04W 72/30; H04B 7/06968; H04W 52/146

(57) ABSTRACT

Apparatuses and methods for uplink power control based on on-demand synchronization signal block (SSB). A method performed by a user equipment includes receiving a set of higher layer parameters for a secondary cell (SCell) and identifying, based on the set of higher layer parameters, first and second configurations for first and second synchronization signal and physical broadcast channel (SS/PBCH) blocks, respectively, the first and second configurations including, first and second frequency locations for the first and second SS/PBCH blocks, respectively, and first and second indications of first and second sets of actually transmitted SS/PBCH block indexes for the first and second SS/PBCH block, respectively. The method further includes determining a SS/PBCH block index to be associated with a transmission control information (TCI) state and determining, when applying the TCI state, that transmission of the second SS/PBCH block corresponding to the SS/PBCH block index is not deactivated.

### CROSS-REFERENCE TO RELATED AND CLAIM OF PRIORITY

The present application claims priority under 35 U.S.C. § 119 (e) to U.S. Provisional Patent Application No. 63/801,449 filed on May 7, 2025; U.S. Provisional Patent Application No. 63/863,063 filed on Aug. 13, 2025; U.S. Provisional Patent Application No. 63/906,803 filed on Oct. 28, 2025; and U.S. Provisional Patent Application No. 63/929,295 filed on Dec. 2, 2025, which are hereby incorporated by reference in their entirety.

### TECHNICAL FIELD

The present disclosure relates generally to wireless communication systems and, more specifically, the present disclosure is related to a method and apparatus for uplink power control based on on-demand synchronization signal and/or physical broadcast channel block (SS/PBCH block or SSB).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for uplink power control based on on-demand SSB.

In one embodiment, a user equipment (UE) in a wireless communication system is provided. The UE includes a transceiver configured to receive a set of higher layer parameters for a secondary cell (SCell) and a processor operably coupled to the transceiver. The processor is configured to identify, based on the set of higher layer parameters a first configuration for a first synchronization signal and physical broadcast channel (SS/PBCH) block, the first configuration including a first frequency location for the first SS/PBCH block and a first indication of a first set of actually transmitted SS/PBCH block indexes for the first SS/PBCH block, and a second configuration for a second SS/PBCH block, the second configuration including a second frequency location for the second SS/PBCH block and a second indication of a second set of actually transmitted SS/PBCH block indexes for the second SS/PBCH block; determine a SS/PBCH block index to be associated with a transmission control information (TCI) state; and determine, when applying the TCI state, that transmission of the second SS/PBCH block corresponding to the SS/PBCH block index is not deactivated.

In another embodiment, a method performed by a UE in a wireless communication system is provided. The method includes receiving a set of higher layer parameters for a SCell and identifying, based on the set of higher layer parameters, a first configuration for a first SS/PBCH block, the first configuration including, a first frequency location for the first SS/PBCH block, and a first indication of a first set of actually transmitted SS/PBCH block indexes for the first SS/PBCH block, and a second configuration for a second SS/PBCH block, the second configuration including, a second frequency location for the second SS/PBCH block, and a second indication of a second set of actually transmitted SS/PBCH block indexes for the second SS/PBCH block. The method further includes determining a SS/PBCH block index to be associated with a TCI state and determining, when applying the TCI state, that transmission of the second SS/PBCH block corresponding to the SS/PBCH block index is not deactivated.

In yet another embodiment, a base station (BS) in a wireless communication system is provided. The BS includes a processor configured to determine a first configuration for a first SS/PBCH block, the first configuration including, a first frequency location for the first SS/PBCH block, and a first indication of a first set of actually transmitted SS/PBCH block indexes for the first SS/PBCH block, and determine a second configuration for a second SS/PBCH block, the second configuration including, a second frequency location for the second SS/PBCH block, and a second indication of a second set of actually transmitted SS/PBCH block indexes for the second SS/PBCH block. The BS further includes a transceiver operably coupled to the processor. The transceiver is configured to transmit, to a UE, a set of higher layer parameters for a SCell, the set of higher layer parameters including the first configuration and the second configuration. The processor is further configured to, determine a SS/PBCH block index to be associated with a TCI state and determine, when applying the TCI state, that transmission of the second SS/PBCH block corresponding to the SS/PBCH block index is not deactivated.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example method performed by a UE in a wireless communication system according to embodiments of the present disclosure; and

FIG. 6 illustrates an example of an on-demand SS/PBCH block (OD-SSB) based operation using a different beam according to embodiments of the present disclosure; and

FIG. 7 illustrates an example method performed by a UE in a wireless communication system according to embodiments of the present disclosure.

### DETAILED DESCRIPTION

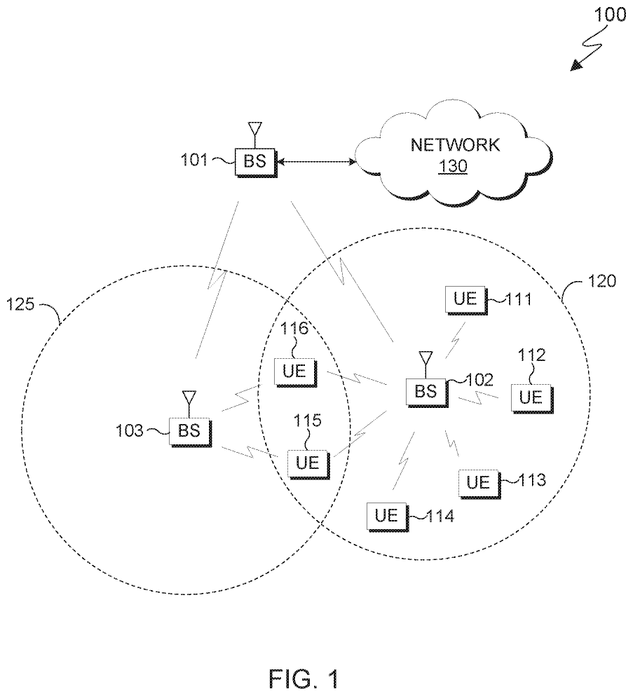

FIGS. 1-7 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v16.6.0, “NR; Physical channels and modulation” (herein, “REF 1”); 3GPP TS 38.212 v16.6.0, “NR; Multiplexing and channel coding” (herein, “REF 2”); 3GPP TS 38.213 v16.6.0, “NR; Physical layer procedures for control” (herein, “REF 3”); 3GPP TS 38.214 v16.6.0, “NR; Physical layer procedures for data” (herein, “REF 4”); and 3GPP TS 38.331 v16.5.0, “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for supporting uplink power control based on on-demand SSB. In certain embodiments, one or more of the BSs 101-103 include circuitry, programing, or a combination thereof to enable uplink power control based on on-demand SSB.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

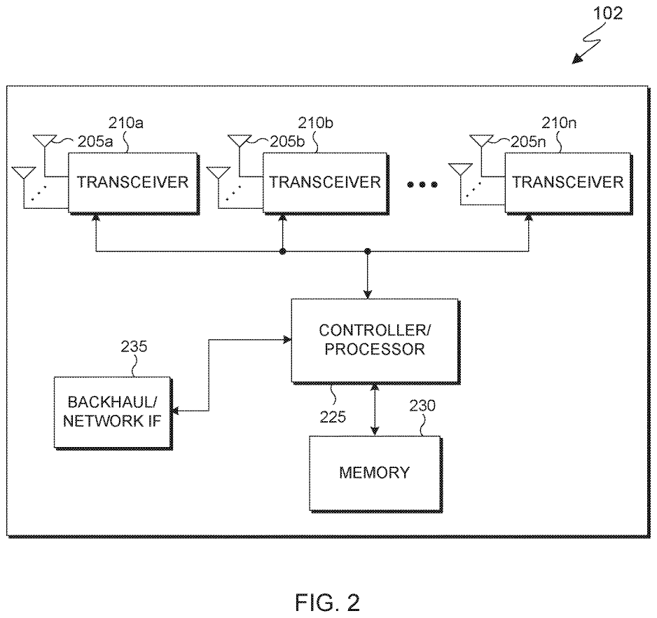

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling uplink power control based on on-demand SSB. Any of a wide variety of other functions could be supported in the BS 102 by the controller/processor 225.

The controller/processor 225 is also capable of executing programs and other processes resident in the memory 230, such as processes to enable uplink power control based on on-demand SSB. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

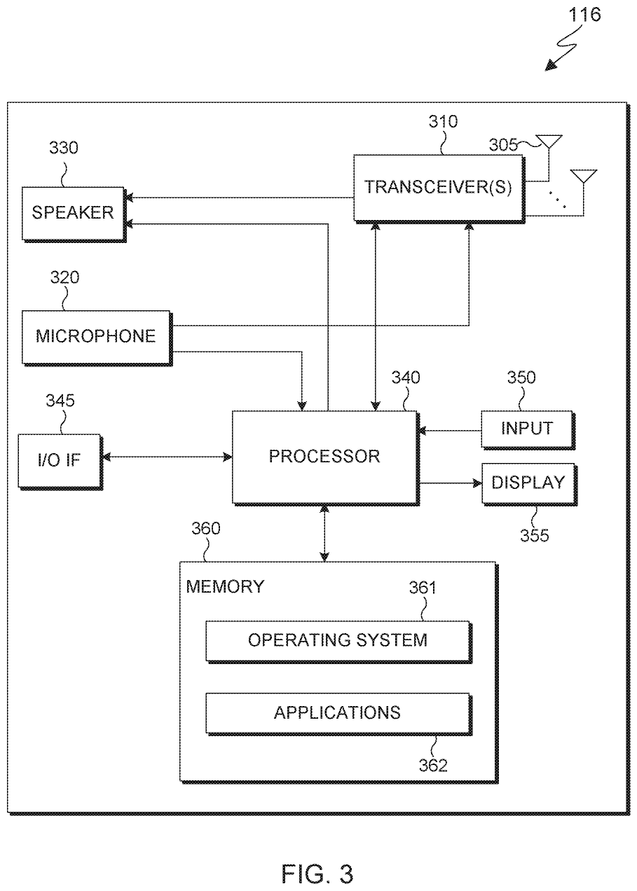

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for supporting uplink power control based on on-demand SSB as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

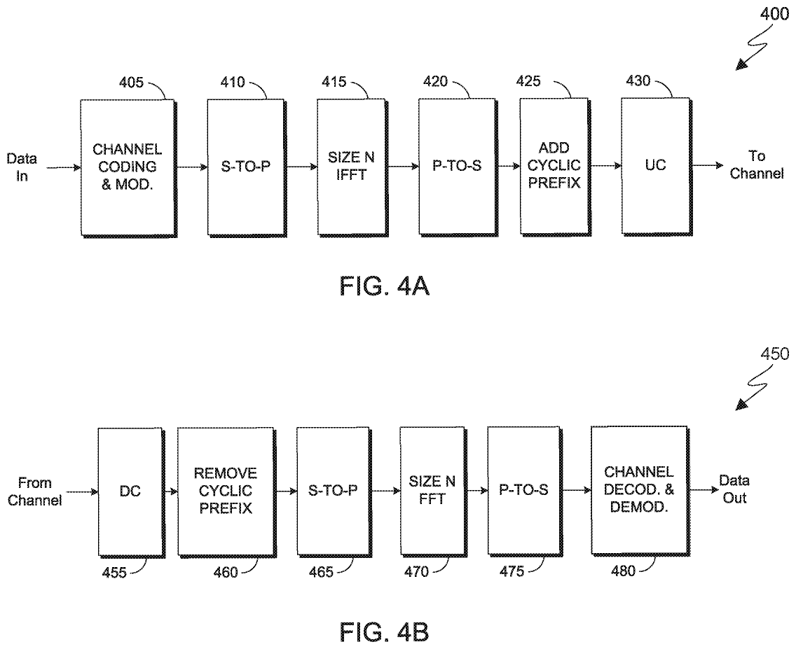

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting uplink power control based on on-demand SSB as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In new radio (NR), for a secondary cell (SCell) implemented with periodic synchronization signal/physical broadcast channel (SS/PBCH) block transmission, or always-on SSB (AO-SSB), a UE can be provided with a configuration for radio resource management (RRM) measurement based on the periodic SS/PBCH block, wherein the configuration can be provided by a RRC parameter. After the RRM measurement, the gNB can provide a configuration of the SCell, e.g., by another RRC parameter. The UE can be further provided with a medium access control (MAC) control element (CE) indicating an activation of the SCell, and by using the periodic SS/PBCH blocks on the SCell, or tracking reference signal (TRS) if configured, or the SS/PBCH blocks on the primary cell (PCell) when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH block for resynchronization. Since SS/PBCH block is transmitted on the SCell periodically, the power consumption for SS/PBCH block can be significantly large. To reduce the power consumption, on-demand SS/PBCH block (OD-SSB) can be supported on the SCell. This disclosure focuses on the procedure for uplink power control (e.g., PUSCH, PUCCH, SRS, and/or PRACH) based on the OD-SSB, as well as radio link monitoring and/or link recovery procedure based on the OD-SSB.

For one example, this disclosure can be applicable for RRC_CONNECTED mode.

For another example, this disclosure can be applicable for RRC_IDLE mode.

For yet another example, this disclosure can be applicable for RRC_INACTIVE mode.

For one example, this disclosure can be applicable for a PCell.

For another example, this disclosure can be applicable for a SCell.

For yet another example, this disclosure can be applicable for a primary secondary cell (PSCell).

For one example, this disclosure can be applicable for AO-SSB as cell-defining SSB (e.g., with associated SIB1 transmission).

For another example, this disclosure can be applicable for AO-SSB as non-cell-defining SSB (e.g., without associated SIB1 transmission).

For one example, this disclosure can be applicable for AO-SSB located at a frequency layer given by a synchronization raster entry.

For another example, this disclosure can be applicable for AO-SSB located at a frequency layer not given by a synchronization raster entry.

As introduced above, this disclosure focuses on the UE procedures based on on-demand SSB (OD-SSB), including an uplink power control procedure. More precisely, the following aspects, among others, are included in this disclosure:
General considerations on UE procedures based on on-demand SSB
Uplink power control with unified transmission configuration indicator (TCI) state operation
Uplink power control without unified TCI state operation
   Common SSB Type(s) for Uplink Channels
   Separate SSB Type(s) for physical uplink shared channel (PUSCH)
   Separate SSB Type(s) for physical uplink control channel (PUCCH)
   Separate SSB Type(s) for sounding reference signal (SRS)
Power control for physical random access channel (PRACH) based on on-demand SSB
Radio link monitoring based on on-demand SSB
Link recovery procedure based on on-demand SSB

As for the general considerations on UE procedures based on on-demand SSB, in one embodiment, for a serving configured with on-demand SS/PBCH block (OD-SSB), a UE can perform operations based on the OD-SSB, e.g., when the OD-SSB is transmitted, according to at least one of the following example operations.
Example 1: L1 measurement
Example 2: L3 measurement
Example 3: uplink power control (e.g., downlink pathloss calculation)
Example 4: radio link monitoring
Example 5: link recovery procedure

For one example, the uplink power control can be for a PUSCH.

For another example, the uplink power control can be for a PUCCH.

For yet another example, the uplink power control can be for an SRS.

For yet another example, the uplink power control can be for a PRACH.

In one example, the OD-SSB can be used as the RS for calculating the downlink pathloss estimate in dB in the uplink power control, e.g., the term PL_{b,f,c}(q_{d}).

For one example, in a first case (Case 1) that there is no always-on SS/PBCH block (AO-SSB) transmission (or periodic SSB transmission) on the same cell as the OD-SSB, the example procedure (e.g., from Example 1 to Example 5) can be based on the OD-SSB only.
For one further implementation, the higher layer parameter providing the center frequency of the AO-SSB (e.g., absoluteFrequencySSB) can be absent for Case 1.
For another further implementation, the RS resource corresponding to a SS/PBCH block configured for the example procedure refers to the OD-SSB configured for the cell.
For yet another further implementation, the example of using OD-SSB only for the example UE procedure can be based on a configuration by the higher layer parameters, e.g., according to embodiments and examples of the present disclosure.

For another example, in a second case (Case 2) that there is always-on SS/PBCH block (AO-SSB) transmission (or periodic SSB transmission) on the same cell as the OD-SSB, the example procedure (e.g., from Example 1 to Example 5) can be based on the OD-SSB only, or AO-SSB only, or both the OD-SSB and the AO-SSB, according to embodiments and examples of the present disclosure.
For one further implementation, the higher layer parameter providing the center frequency of the AO-SSB (e.g., absoluteFrequencySSB) can be present for Case 2.

For one further implementation, the type(s) of SSB (e.g., from AO-SSB, and/or OD-SSB) the UE determines for one example procedure (e.g., from Example 1 to Example 5), e.g., according to examples of the present disclosure, can be used for another example procedure (e.g., from Example 1 to Example 5).

In the present disclosure, uplink power control with unified TCI state operation is provided.

In one embodiment, a UE can be provided by higher layer parameters (e.g., PathlossReferenceRS) to configure a reference signal (RS) to be used for pathloss estimation for PUSCH, PUCCH and SRS for the unified TCI state operation, and when the RS is a SS/PBCH block, the SS/PBCH block can be an OD-SSB; or determines a SS/PBCH block for pathloss estimation for PUSCH, PUCCH and SRS, e.g., when the higher layer parameters are not provided, and the SS/PBCH block can also be an OD-SSB.

For one example, the configuration for the RS (e.g., PathlossReferenceRS) can include a field indicating that when the RS is a SSB, which type(s) of SSB (e.g., from AO-SSB, and/or OD-SSB) is used for the pathloss estimation.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.

For another example, the higher layer parameter can provide an explicit field indicating which type(s) of SSB (e.g., from AO-SSB, and/or OD-SSB) is used at least for the pathloss estimation.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for L1 measurement.
For yet another further implementation, the indication by the field can also be used for SSB type(s) for radio link monitoring (RLM), and/or link recovery procedure.

For yet another example, the type(s) of SSB (e.g., from AO-SSB, and/or OD-SSB) used for the pathloss estimation can be determined as the same type(s) of SSB for L1 measurement.
For one instance, there can be a higher layer parameter indicating which type(s) of SSB is used for L1 measurement, and the UE can apply the same type(s) of SSB for pathloss estimation.
For another instance, if a UE determines type(s) of SSB is used for L1 measurement, e.g., based on whether the center frequency of the AO-SSB and the center frequency of the OD-SSB are the same, then the UE can apply the same type(s) of SSB for pathloss estimation.

For yet another example, the type(s) of SSB (e.g., from AO-SSB, and/or OD-SSB) used for the pathloss estimation can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the pathloss estimation can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform pathloss estimation based on both of OD-SSB and AO-SSB (e.g., according to example of the present disclosure), the UE may maintain two pathloss estimates when calculating the total number of maintained pathloss estimates.
For one further implementation, this example can be applicable at least when the UE selects both OD-SSB and AO-SSB for pathloss estimation.

For another example, when a UE identifies to perform pathloss estimation based on both of OD-SSB and AO-SSB (e.g., according to example of the present disclosure), the UE may select OD-SSB, or AO-SSB, or OD-SSB and AO-SSB for pathloss estimation.

For one example, the type(s) of SSB (e.g., from AO-SSB, and/or OD-SSB) the UE determined for the pathloss estimation (e.g., according to example of the present disclosure) can also be applicable to PRACH power control (e.g., pathloss estimation for PRACH).

Further in the present disclosure, uplink power control without unified TCI state operation is provided.

In various embodiments, common SSB type(s) for uplink channels are provided.

In one embodiment, a UE can be provided by higher layer parameters to configure a reference signal (RS) to be used for pathloss estimation for PUSCH, PUCCH, or SRS, respectively, and when the RS is a SS/PBCH block, the type(s) of SSB (e.g., from AO-SSB, and/or OD-SSB) can be common at least for one of PUSCH, PUCCH, or SRS; or determines a SS/PBCH block for pathloss estimation for PUSCH, PUCCH, or SRS, respectively, e.g., when the higher layer parameters are not provided, then the type(s) of SSB (e.g., from AO-SSB, and/or OD-SSB) can also be common at least for one of PUSCH, PUCCH, or SRS.

For one example, the higher layer parameter can provide an explicit field indicating which type(s) of SSB (e.g., from AO-SSB, and/or OD-SSB) is used at least for the pathloss estimation at least for one of PUSCH, PUCCH, or SRS.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for L1 measurement.
For yet another further implementation, the indication by the field can also be used for SSB type(s) for radio link monitoring (RLM), and/or link recovery procedure.
For yet another further implementation, there can be multiple higher layer parameter providing indications on which type(s) of SSB (e.g., from AO-SSB, and/or OD-SSB) used for the pathloss estimation for each of PUSCH, PUCCH, or SRS, and the UE can expect the indications are the same (e.g., indicating same type(s) of SSB).
For yet another further implementation, the higher layer parameter can be same as the one providing the indication on which type(s) of SSB (e.g., from AO-SSB, and/or OD-SSB) used for pathloss estimation for PUSCH, PUCCH and SRS for the unified TCI state operation.

For yet another example, the type(s) of SSB (e.g., from AO-SSB, and/or OD-SSB) used for the pathloss estimation at least for one of PUSCH, PUCCH, or SRS can be determined as the same type(s) of SSB for L1 measurement.
For one instance, there can be a higher layer parameter indicating which type(s) of SSB is used for L1 measurement, and the UE can apply the same type(s) of SSB for pathloss estimation at least for one of PUSCH, PUCCH, or SRS.
For another instance, if a UE determines type(s) of SSB is used for L1 measurement, e.g., based on whether the center frequency of the AO-SSB and the center frequency of the OD-SSB are the same, then the UE can apply the same type(s) of SSB for pathloss estimation at least for one of PUSCH, PUCCH, or SRS.

For yet another example, the type(s) of SSB (e.g., from AO-SSB, and/or OD-SSB) used for the pathloss estimation at least for one of PUSCH, PUCCH, or SRS can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the pathloss estimation at least for one of PUSCH, PUCCH, or SRS can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform pathloss estimation at least for one of PUSCH, PUCCH, or SRS based on both of OD-SSB and AO-SSB (e.g., according to example of the present disclosure), the UE may maintain two pathloss estimates when calculating the total number of maintained pathloss estimates.
For one further implementation, this example can be applicable at least when the UE selects both OD-SSB and AO-SSB for pathloss estimation.

For another example, when a UE identifies to perform pathloss estimation at least for one of PUSCH, PUCCH, or SRS based on both of OD-SSB and AO-SSB (e.g., according to example of the present disclosure), the UE may select OD-SSB, or AO-SSB, or OD-SSB and AO-SSB for pathloss estimation at least for one of PUSCH, PUCCH, or SRS.

For one example, the determined type(s) of SSB (e.g., according to example of the present disclosure) is applicable to at least one of the following instances.
For one instance, the determined type(s) of SSB is applicable to the SSB for PUSCH pathloss estimation, when the RS for PUSCH pathloss estimation is configured as a SSB by higher layer parameter (e.g., PUSCH-PathlossReferenceRS).
For another instance, the determined type(s) of SSB is applicable to the determined SSB for PUSCH pathloss estimation, e.g., when the RS for PUSCH pathloss estimation by higher layer parameter (e.g., PUSCH-PathlossReferenceRS) is not provided.
For yet another instance, the determined type(s) of SSB is applicable to the SSB for PUCCH pathloss estimation, when the RS for PUCCH pathloss estimation is configured as a SSB by higher layer parameter (e.g., PUCCH-PathlossReferenceRS, and/or PUCCH-SpatialRelationInfo).
For yet another instance, the determined type(s) of SSB is applicable to the determined SSB for PUCCH pathloss estimation, e.g., when the RS for PUCCH pathloss estimation by higher layer parameter (e.g., PUCCH-PathlossReferenceRS, and/or PUCCH-SpatialRelationInfo) is not provided.
For yet another instance, the determined type(s) of SSB is applicable to the SSB for SRS pathloss estimation, when the RS for SRS pathloss estimation is configured as a SSB by higher layer parameter (e.g., PathlossReferenceRS-Config in SRS-Config, and/or SRS-SpatialRelationInfo).
For yet another instance, the determined type(s) of SSB is applicable to the determined SSB for SRS pathloss estimation, e.g., when the RS for SRS pathloss estimation by higher layer parameter (e.g., PathlossReferenceRS-Config in SRS-Config, and/or SRS-SpatialRelationInfo) is not provided.

For one example, the type(s) of SSB (e.g., from AO-SSB, and/or OD-SSB) the UE determined for the pathloss estimation at least for one of PUSCH, PUCCH, or SRS (e.g., according to example of the present disclosure) can also be applicable to PRACH power control (e.g., pathloss estimation for PRACH).

In various embodiments, separate SSB type(s) for PUSCH are provided.

In one embodiment, a UE can be provided by higher layer parameters (e.g., PUSCH-PathlossReferenceRS) to configure a reference signal (RS) to be used for pathloss estimation for PUSCH, and when the RS is a SS/PBCH block, the SS/PBCH block can be an OD-SSB; or determines a SS/PBCH block for pathloss estimation for PUSCH, e.g., when the higher layer parameters are not provided, and the SS/PBCH block can also be an OD-SSB.

For one example, the configuration for the RS (e.g., PUSCH-PathlossReferenceRS) can include a field indicating that when the RS is a SSB, which type(s) of SSB (e.g., from AO-SSB, and/or OD-SSB) is used for the pathloss estimation for PUSCH.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.

For another example, the higher layer parameter can provide an explicit field indicating which type(s) of SSB (e.g., from AO-SSB, and/or OD-SSB) is used at least for the pathloss estimation for PUSCH.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for L1 measurement.
For yet another further implementation, the indication by the field can also be used for SSB type(s) for radio link monitoring (RLM), and/or link recovery procedure.

For yet another example, the type(s) of SSB (e.g., from AO-SSB, and/or OD-SSB) used for the pathloss estimation for PUSCH can be determined as the same type(s) of SSB for L1 measurement.
For one instance, there can be a higher layer parameter indicating which type(s) of SSB is used for L1 measurement, and the UE can apply the same type(s) of SSB for pathloss estimation for PUSCH.
For another instance, if a UE determines type(s) of SSB is used for L1 measurement, e.g., based on whether the center frequency of the AO-SSB and the center frequency of the OD-SSB are the same, then the UE can apply the same type(s) of SSB for pathloss estimation for PUSCH.

For yet another example, the type(s) of SSB (e.g., from AO-SSB, and/or OD-SSB) used for the pathloss estimation for PUSCH can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the pathloss estimation for PUSCH can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform pathloss estimation based on both of OD-SSB and AO-SSB (e.g., according to example of the present disclosure), the UE may maintain two pathloss estimates when calculating the total number of maintained pathloss estimates.
For one further implementation, this example can be applicable at least when the UE selects both OD-SSB and AO-SSB for pathloss estimation.

For another example, when a UE identifies to perform pathloss estimation for PUSCH based on both of OD-SSB and AO-SSB (e.g., according to example of the present disclosure), the UE may select OD-SSB, or AO-SSB, or OD-SSB and AO-SSB for pathloss estimation for PUSCH.

For one example, the determined type(s) of SSB (e.g., according to example of the present disclosure) is applicable to at least one of the following instances.
For one instance, the determined type(s) of SSB is applicable to the SSB for PUSCH pathloss estimation, when the RS for PUSCH pathloss estimation is configured as a SSB by higher layer parameter (e.g., PUSCH-PathlossReferenceRS).
For another instance, the determined type(s) of SSB is applicable to the determined SSB for PUSCH pathloss estimation, e.g., when the RS for PUSCH pathloss estimation by higher layer parameter (e.g., PUSCH-PathlossReferenceRS) is not provided.

For one example, the type(s) of SSB (e.g., from AO-SSB, and/or OD-SSB) the UE determined for the pathloss estimation for PUSCH (e.g., according to example of the present disclosure) can also be applicable to PRACH power control (e.g., pathloss estimation for PRACH).

In various embodiments, separate SSB type(s) for PUCCH are provided.

In one embodiment, a UE can be provided by higher layer parameters (e.g., PUCCH-PathlossReferenceRS, and/or PUCCH-SpatialRelationInfo) to configure a reference signal (RS) to be used for pathloss estimation for PUCCH, and when the RS is a SS/PBCH block, the SS/PBCH block can be an OD-SSB; or determines a SS/PBCH block for pathloss estimation for PUCCH, e.g., when the higher layer parameters are not provided, and the SS/PBCH block can also be an OD-SSB.

For one example, the configuration for the RS (e.g., PUCCH-PathlossReferenceRS, and/or PUCCH-SpatialRelationInfo) can include a field indicating that when the RS is a SSB, which type(s) of SSB (e.g., from AO-SSB, and/or OD-SSB) is used for the pathloss estimation for PUCCH.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.

For another example, the higher layer parameter can provide an explicit field indicating which type(s) of SSB (e.g., from AO-SSB, and/or OD-SSB) is used at least for the pathloss estimation for PUCCH.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for L1 measurement.
For yet another further implementation, the indication by the field can also be used for SSB type(s) for radio link monitoring (RLM), and/or link recovery procedure.

For yet another example, the type(s) of SSB (e.g., from AO-SSB, and/or OD-SSB) used for the pathloss estimation for PUCCH can be determined as the same type(s) of SSB for L1 measurement.
For one instance, there can be a higher layer parameter indicating which type(s) of SSB is used for L1 measurement, and the UE can apply the same type(s) of SSB for pathloss estimation for PUCCH.
For another instance, if a UE determines type(s) of SSB is used for L1 measurement, e.g., based on whether the center frequency of the AO-SSB and the center frequency of the OD-SSB are the same, then the UE can apply the same type(s) of SSB for pathloss estimation for PUCCH.

For yet another example, the type(s) of SSB (e.g., from AO-SSB, and/or OD-SSB) used for the pathloss estimation for PUCCH can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the pathloss estimation for PUCCH can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform pathloss estimation based on both of OD-SSB and AO-SSB (e.g., according to example of the present disclosure), the UE may maintain two pathloss estimates when calculating the total number of maintained pathloss estimates.
For one further implementation, this example can be applicable at least when the UE selects both OD-SSB and AO-SSB for pathloss estimation.

For another example, when a UE identifies to perform pathloss estimation for PUCCH based on both of OD-SSB and AO-SSB (e.g., according to example of the present disclosure), the UE may select OD-SSB, or AO-SSB, or OD-SSB and AO-SSB for pathloss estimation for PUCCH.

For one example, the determined type(s) of SSB (e.g., according to example of the present disclosure) is applicable to at least one of the following instances.
For one instance, the determined type(s) of SSB is applicable to the SSB for PUCCH pathloss estimation, when the RS for PUCCH pathloss estimation is configured as a SSB by higher layer parameter (e.g., PUCCH-PathlossReferenceRS, and/or PUCCH-SpatialRelationInfo).
For another instance, the determined type(s) of SSB is applicable to the determined SSB for PUCCH pathloss estimation, e.g., when the RS for PUCCH pathloss estimation by higher layer parameter (e.g., PUCCH-PathlossReferenceRS, and/or PUCCH-SpatialRelationInfo) is not provided.

For one example, the type(s) of SSB (e.g., from AO-SSB, and/or OD-SSB) the UE determined for the pathloss estimation for PUCCH (e.g., according to example of the present disclosure) can also be applicable to PRACH power control (e.g., pathloss estimation for PRACH).

In various embodiments, separate SSB type(s) for SRS are provided.

In one embodiment, a UE can be provided by higher layer parameters (e.g., PathlossReferenceRS-Config in SRS-Config, and/or SRS-SpatialRelationInfo) to configure a reference signal (RS) to be used for pathloss estimation for SRS, and when the RS is a SS/PBCH block, the SS/PBCH block can be an OD-SSB; or determines a SS/PBCH block for pathloss estimation for SRS, e.g., when the higher layer parameters are not provided, and the SS/PBCH block can also be an OD-SSB.

For one example, the configuration for the RS (e.g., PathlossReferenceRS-Config in SRS-Config, and/or SRS-SpatialRelationInfo) can include a field indicating that when the RS is a SSB, which type(s) of SSB (e.g., from AO-SSB, and/or OD-SSB) is used for the pathloss estimation for SRS.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the determined type(s) of SSB is applicable to the SSB for SRS pathloss estimation, when the RS for SRS pathloss estimation is configured as a SSB by higher layer parameter (e.g., PathlossReferenceRS-Config in SRS-Config, and/or SRS-SpatialRelationInfo).
For yet another further implementation, the determined type(s) of SSB is applicable to the determined SSB for SRS pathloss estimation, e.g., when the RS for SRS pathloss estimation by higher layer parameter (e.g., PathlossReferenceRS-Config in SRS-Config, and/or SRS-SpatialRelationInfo) is not provided.

For another example, the higher layer parameter can provide an explicit field indicating which type(s) of SSB (e.g., from AO-SSB, and/or OD-SSB) is used at least for the pathloss estimation for SRS.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for L1 measurement.
For yet another further implementation, the indication by the field can also be used for SSB type(s) for radio link monitoring (RLM), and/or link recovery procedure.

For yet another example, the type(s) of SSB (e.g., from AO-SSB, and/or OD-SSB) used for the pathloss estimation for SRS can be determined as the same type(s) of SSB for L1 measurement.
For one instance, there can be a higher layer parameter indicating which type(s) of SSB is used for L1 measurement, and the UE can apply the same type(s) of SSB for pathloss estimation for SRS.
For another instance, if a UE determines type(s) of SSB is used for L1 measurement, e.g., based on whether the center frequency of the AO-SSB and the center frequency of the OD-SSB are the same, then the UE can apply the same type(s) of SSB for pathloss estimation for SRS.

For yet another example, the type(s) of SSB (e.g., from AO-SSB, and/or OD-SSB) used for the pathloss estimation for SRS can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the pathloss estimation for SRS can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform pathloss estimation based on both of OD-SSB and AO-SSB (e.g., according to example of the present disclosure), the UE may maintain two pathloss estimates when calculating the total number of maintained pathloss estimates.
For one further implementation, this example can be applicable at least when the UE selects both OD-SSB and AO-SSB for pathloss estimation.

For another example, when a UE identifies to perform pathloss estimation for SRS based on both of OD-SSB and AO-SSB (e.g., according to example of the present disclosure), the UE may select OD-SSB, or AO-SSB, or OD-SSB and AO-SSB for pathloss estimation for SRS.

For one example, the determined type(s) of SSB (e.g., according to example of the present disclosure) is applicable to at least one of the following instances.
For one instance, the determined type(s) of SSB is applicable to the SSB for SRS pathloss estimation, when the RS for SRS pathloss estimation is configured as a SSB by higher layer parameter (e.g., PathlossReferenceRS-Config in SRS-Config, and/or SRS-SpatialRelationInfo).
For another instance, the determined type(s) of SSB is applicable to the determined SSB for SRS pathloss estimation, e.g., when the RS for SRS pathloss estimation by higher layer parameter (e.g., PathlossReferenceRS-Config in SRS-Config, and/or SRS-SpatialRelationInfo) is not provided.

For one example, the type(s) of SSB (e.g., from AO-SSB, and/or OD-SSB) the UE determined for the pathloss estimation for SRS (e.g., according to example of the present disclosure) can also be applicable to PRACH power control (e.g., pathloss estimation for PRACH).

Further in the present disclosure, power control for PRACH is provided.

In one embodiment, a UE can determine a SS/PBCH block for pathloss estimation for PRACH, and the SS/PBCH block can be an OD-SSB.

For one example, a higher layer parameter can provide an explicit field indicating which type(s) of SSB (e.g., from AO-SSB, and/or OD-SSB) is used at least for the pathloss estimation for PRACH.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for pathloss estimation is AO-SSB, e.g., at least for Case 2.
For yet another further implementation, when the field is absent, the UE assumes the type(s) of SSB for pathloss estimation is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for La measurement.
For yet another further implementation, the indication by the field can also be used for SSB type(s) for radio link monitoring (RLM), and/or link recovery procedure.

For another example, the type(s) of SSB (e.g., from AO-SSB, and/or OD-SSB) used for the pathloss estimation for PRACH can be determined as the same type(s) of SSB for L1 measurement.
For one instance, there can be a higher layer parameter indicating which type(s) of SSB is used for L1 measurement, and the UE can apply the same type(s) of SSB for pathloss estimation for PRACH.
For another instance, if a UE determines type(s) of SSB is used for L1 measurement, e.g., based on whether the center frequency of the AO-SSB and the center frequency of the OD-SSB are the same, then the UE can apply the same type(s) of SSB for pathloss estimation for PRACH.

For yet another example, the type(s) of SSB (e.g., from AO-SSB, and/or OD-SSB) used for the pathloss estimation for PRACH can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the pathloss estimation for PRACH can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform pathloss estimation based on both of OD-SSB and AO-SSB (e.g., according to example of the present disclosure), the UE may maintain two pathloss estimates when calculating the total number of maintained pathloss estimates.
For one further implementation, this example can be applicable at least when the UE selects both OD-SSB and AO-SSB for pathloss estimation.

For one example, the determined type(s) of SSB (e.g., according to example of the present disclosure) is applicable to at least one of the following instances.
For one instance, the determined type(s) of SSB is applicable to the determined SSB for PRACH pathloss estimation.

Further in the present disclosure, radio link monitoring is provided.

In one embodiment, a UE can be provided by higher layer parameters (e.g., RadioLinkMonitoringRS) to configure a reference signal (RS) to be used for radio link monitoring (RLM), and when the RS is a SS/PBCH block, the SS/PBCH block can be an OD-SSB; or determines a SS/PBCH block for radio link monitoring, e.g., when the higher layer parameters are not provided, and the SS/PBCH block can also be an OD-SSB.

For one example, the configuration for the RS (e.g., RadioLinkMonitoringRS) can include a field indicating that when the RS is a SSB, which type(s) of SSB (e.g., from AO-SSB, and/or OD-SSB) is used for the RLM.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for RLM is AO-SSB, e.g., at least for Case 2.
For yet another further implementation, when the field is absent, the UE assumes the type(s) of SSB for RLM is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.

For another example, the higher layer parameter can provide an explicit field indicating which type(s) of SSB (e.g., from AO-SSB, and/or OD-SSB) is used for the RLM.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for RLM is AO-SSB, e.g., at least for Case 2.
For yet another further implementation, when the field is absent, the UE assumes the type(s) of SSB for RLM is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for L1 measurement, and/or uplink power control.

For yet another example, the type(s) of SSB (e.g., from AO-SSB, and/or OD-SSB) used for the RLM can be determined as the same type(s) of SSB for L1 measurement.
For one instance, there can be a higher layer parameter indicating which type(s) of SSB is used for L1 measurement, and the UE can apply the same type(s) of SSB for RLM.
For another instance, if a UE determines type(s) of SSB is used for L1 measurement, e.g., based on whether the center frequency of the AO-SSB and the center frequency of the OD-SSB are the same, then the UE can apply the same type(s) of SSB for RLM.

For yet another example, the type(s) of SSB (e.g., from AO-SSB, and/or OD-SSB) used for the RLM can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the RLM can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform RLM based on both of OD-SSB and AO-SSB (e.g., according to example of the present disclosure), the UE may perform two RLM procedures when calculating the total number of RLM procedures.
For one further implementation, this example can be applicable at least when the UE selects both OD-SSB and AO-SSB for RLM.

For another example, when a UE identifies to perform RLM based on both of OD-SSB and AO-SSB (e.g., according to example of the present disclosure), the UE may select OD-SSB, or AO-SSB, or OD-SSB and AO-SSB for RLM.

Further in the present disclosure, a link recovery procedure is provided.

In one embodiment, a UE can be provided by higher layer parameters (e.g., candidateBeamRSList or candidateBeamRSListExt or candidateBeamRS-List or candidateBeamRS-List2) to configure a reference signal (RS) to be used for radio link quality measurements and/or link recovery procedure, and when the RS is a SS/PBCH block, the SS/PBCH block can be an OD-SSB.

For one example, the configuration for the RS (e.g., candidateBeamRSList or candidateBeamRSListExt or candidateBeamRS-List or candidateBeamRS-List2) can include a field indicating that when the RS is a SSB, which type(s) of SSB (e.g., from AO-SSB, and/or OD-SSB) is used for the link recovery procedure.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for link recovery procedure is AO-SSB, e.g., at least for Case 2.
For yet another further implementation, when the field is absent, the UE assumes the type(s) of SSB for link recovery procedure is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.

For another example, the higher layer parameter can provide an explicit field indicating which type(s) of SSB (e.g., from AO-SSB, and/or OD-SSB) is used for the link recovery procedure.
For one further implementation, the field can indicate the SSB is AO-SSB or OD-SSB.
For another further implementation, the field can indicate the SSB is OD-SSB, or both AO-SSB and OD-SSB.
For yet another further implementation, the field can indicate the SSB is OD-SSB, or AO-SSB, or both AO-SSB and OD-SSB.
For yet another further implementation, for Case 1, the UE expects the field to be configured as OD-SSB only.
For yet another further implementation, the field is only applicable for Case 2.
For yet another further implementation, when the field is absent, the UE assumes the type(s) of SSB for link recovery procedure is AO-SSB, e.g., at least for Case 2.
For yet another further implementation, when the field is absent, the UE assumes the type(s) of SSB for link recovery procedure is OD-SSB, e.g., at least for Case 1.
For yet another further implementation, the field can be configured as both AO-SSB and OD-SSB, when the center frequency of the AO-SSB and the center frequency of the OD-SSB are the same.
For yet another further implementation, the field can be configured as OD-SSB, when the center frequency of the AO-SSB and the center frequency of the OD-SSB are different.
For yet another further implementation, the indication by the field can also be used for SSB type(s) for other UE procedures, such as L1 measurement, and/or uplink power control.

For yet another example, the type(s) of SSB (e.g., from AO-SSB, and/or OD-SSB) used for the link recovery procedure can be determined as the same type(s) of SSB for L1 measurement.
For one instance, there can be a higher layer parameter indicating which type(s) of SSB is used for L1 measurement, and the UE can apply the same type(s) of SSB for link recovery procedure.
For another instance, if a UE determines type(s) of SSB is used for L1 measurement, e.g., based on whether the center frequency of the AO-SSB and the center frequency of the OD-SSB are the same, then the UE can apply the same type(s) of SSB for link recovery procedure.

For yet another example, the type(s) of SSB (e.g., from AO-SSB, and/or OD-SSB) used for the link recovery procedure can be determined as OD-SSB only.
For one further implementation, this example is applicable at least for Case 1.
For another further implementation, this example is applicable for both Case 1 and Case 2.
For yet another further implementation, this example is applicable when the center frequency of the AO-SSB and the center frequency of the OD-SSB are the same.
For yet another further implementation, this example is applicable at least when the center frequency of the AO-SSB and the center frequency of the OD-SSB are different.

For yet another example, the type(s) of SSB (e.g., from AO-SSB, and/or OD-SSB) used for the link recovery procedure can be determined as both AO-SSB and OD-SSB.
For one further implementation, this example is applicable at least for Case 2.
For another further implementation, this example is applicable for both Case 1 and Case 2.
For yet another further implementation, this example is applicable at least when the center frequency of the AO-SSB and the center frequency of the OD-SSB are the same.
For yet another further implementation, this example is applicable when the center frequency of the AO-SSB and the center frequency of the OD-SSB are different.

For one example, when a UE identifies to perform link recovery procedure based on both of OD-SSB and AO-SSB (e.g., according to example of the present disclosure), the UE may perform two radio link recovery procedures when calculating the total number of radio link recovery procedures.
For one further implementation, this example can be applicable at least when the UE selects both OD-SSB and AO-SSB for link recovery procedure.

For another example, when a UE identifies to perform link recovery procedure based on both of OD-SSB and AO-SSB (e.g., according to example of the present disclosure), the UE may select OD-SSB, or AO-SSB, or OD-SSB and AO-SSB for link recovery procedure.

For one example, this embodiment is applicable for link recovery procedure on a SCell.

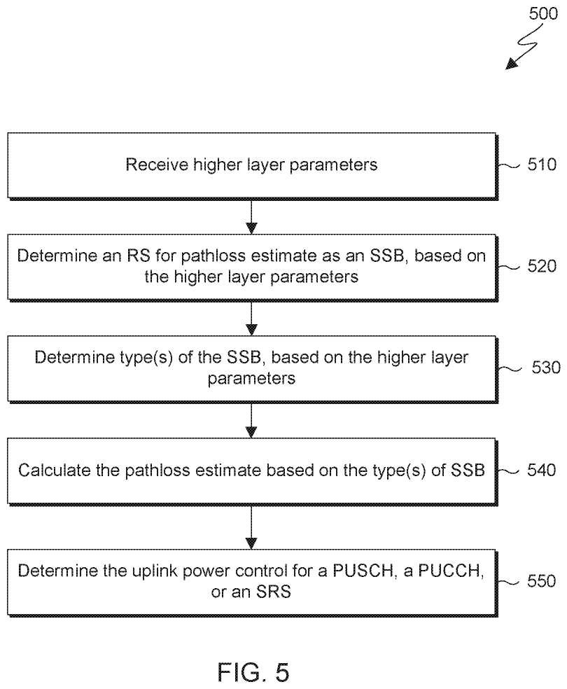

FIG. 5 illustrates an example method 500 performed by a UE in a wireless communication system according to embodiments of the present disclosure. More particularly, FIG. 5 illustrates the example method 500 for using on-demand SS/PBCH block for uplink power control. The method 500 of FIG. 5 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 500 is for illustration only and other embodiments can be used without departing from the scope of the present disclosure.

The method 500 beings with the UE receiving higher layer parameters (510). The UE then determines an RS for pathloss estimate as an SSB, based on the higher layer parameters (520). The UE then determines type(s) of the SSB, based on the higher layer parameters (530). The UE then calculates the pathloss estimate based on the type(s) of SSB (540). The UE then determines the uplink pawer control for a PUSCH, a PUCCH, or a SRS (550).

Although FIG. 5 illustrates one example method 500 of the actions taken by the UE for using an on-demand SS/PBCH block for uplink power control, various changes may be made to FIG. 5. For example, while shown as a series of steps, various steps in FIG. 5 could overlap, occur in parallel, occur in a different order, or occur any number of times.

Further in the present disclosure, an OD-SSB with a new beam is provided.

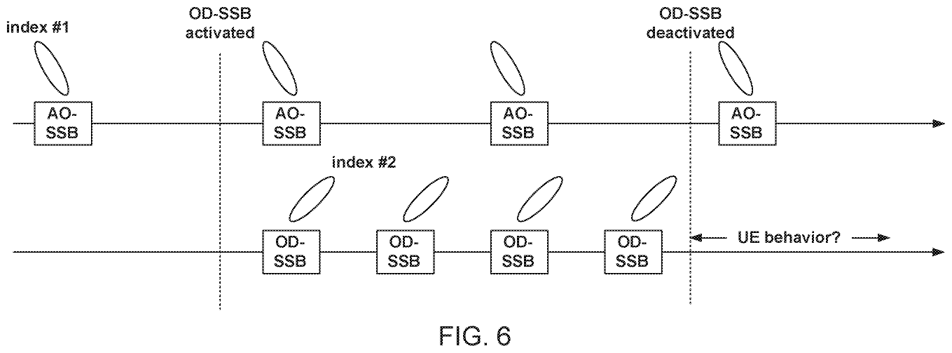

In one embodiment, if a UE is configured with both AO-SSB and OD-SSB in the same cell, and the UE is configured to perform based on the OD-SSB, the UE behavior needs to be specified after the OD-SSB transmission is terminated (e.g., deactivated and/or adapted to be not transmitted). In one further example, the OD-SSB can be based on a different beam of the AO-SSB, as illustrated in FIG. 6.

FIG. 6 illustrates an example of an OD-SSB based operation using a different beam according to embodiments of the present disclosure. For example, the OD-SSB based operation can be implemented by BS 102 of FIG. 1. This example is for illustration only and can be used without departing from the scope of the present disclosure.

In various embodiments, an OD-SSB for measurement is provided.

In one embodiment, if a UE is configured with both AO-SSB and OD-SSB in the same cell, and the UE is configured to perform measurement at least based on OD-SSB, the UE may stop measurement based on OD-SSB after the transmission of OD-SSB is terminated (e.g., deactivated and/or adapted to be not transmitted).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for measurement (e.g., SSB-index or ssb-toMeasure) can be not included in the index(es) of AO-SSB configured for measurement (e.g., SSB-index or ssb-toMeasure), e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the measurement is a L1 measurement (e.g., CSI measurement).
For yet another instance, the measurement is a L3 measurement (e.g., RRM measurement).
For yet another instance, the terminated transmission of OD-SSB corresponds to the index(es) of OD-SSB configured for measurement.
For yet another instance, the embodiment can be applicable also for performing measurement report associated with the measurement.

For yet another further example, if the example instances are not satisfied, the UE may perform measurement based on either AO-SSB or OD-SSB (e.g., OD-SSB corresponding to other index(es) which are not terminated) or both AO-SSB and OD-SSB (e.g., OD-SSB corresponding to other index(es) which are not terminated), based on its implementation.

For another further example, the UE stops measurement reporting after the OD-SSB transmission is terminated (e.g., deactivated and/or adapted to be not transmitted).

For yet another further example, the UE reports measurement results based on transmitted OD-SSB (e.g., OD-SSB corresponding to other index(es) which are not terminated).

For example, for a UE configured with both od-ssb-absoluteFrequency in OD-SSB-Config and absoluteFrequencySSB for a SCell, if a SS/PBCH block index associated with a configuration for measurement and/or measurement report corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE can stop perform the measurement and/or stop the measurement report, when the transmission of SS/PBCH blocks corresponding to the SS/PBCH block index is terminated due to deactivation or adaptation, until applying an indicated new TCI state, if any.

For another example, for a UE configured with OD-SSB-Config and not configured with absoluteFrequencySSB for a SCell, if a SS/PBCH block index associated with a configuration for measurement and/or measurement report corresponds to an actually transmitted SS/PBCH block index provided by od-ssb-PositionsInBurst in the OD-SSB-Config, the UE can stop perform the measurement and/or stop the measurement report, when the transmission of SS/PBCH blocks corresponding to the SS/PBCH block index is terminated due to deactivation or adaptation, until applying an indicated new TCI state, if any.

In another embodiment, if a UE is configured with both AO-SSB and OD-SSB in the same cell, and the UE is configured to perform measurement at least based on OD-SSB, the UE may not expect that the index(es) of OD-SSB configured for measurement (e.g., SSB-index or ssb-toMeasure) can be not included in the index(es) of AO-SSB configured for measurement (e.g., SSB-index or ssb-toMeasure), e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.

For one further example, the index(es) of OD-SSB configured for measurement (e.g., SSB-index or ssb-toMeasure) is same as or a subset of the index(es) of AO-SSB configured for measurement (e.g., SSB-index or ssb-toMeasure).

In yet another embodiment, if a UE is configured with both AO-SSB and OD-SSB in the same cell, and the UE is configured to perform measurement at least based on OD-SSB, and the index(es) of OD-SSB configured for measurement (e.g., SSB-index or ssb-toMeasure) can be not included in the index(es) of AO-SSB configured for measurement (e.g., SSB-index or ssb-toMeasure), e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, then at least one of the following UE behavior can apply:
In one example, the UE does not expect the transmission of OD-SSB to be terminated (e.g., deactivated and/or adapted to be not transmitted), e.g., at least for the indexes not included in the index(es) of AO-SSB.
In another example, the UE does not expect the transmission of OD-SSB to be terminated (e.g., deactivated and/or adapted to be not transmitted), e.g., at least for the indexes not included in the index(es) of AO-SSB and/or when the cell is active.

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for measurement (e.g., SSB-index or ssb-toMeasure) can be not included in the index(es) of AO-SSB configured for measurement (e.g., SSB-index or ssb-toMeasure), e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the measurement is a L1 measurement (e.g., CSI measurement).
For yet another instance, the measurement is a L3 measurement (e.g., RRM measurement).
For yet another instance, the terminated transmission of OD-SSB corresponds to the index(es) of OD-SSB configured for measurement.
For yet another instance, the embodiment can be applicable also for performing measurement report associated with the measurement.

For example, for a UE configured with both od-ssb-absoluteFrequency in OD-SSB-Config and absoluteFrequencySSB for a SCell, if a SS/PBCH block index associated with a configuration for measurement and/or measurement report corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE does not expect the transmission of SS/PBCH blocks corresponding to the SS/PBCH block index is terminated due to deactivation or adaptation, e.g., until applying an indicated new TCI state, if any, or e.g., when performing the measurement or measurement report.

For another example, for a UE configured with OD-SSB-Config and not configured with absoluteFrequencySSB for a SCell, if a SS/PBCH block index associated with a configuration for measurement and/or measurement report corresponds to an actually transmitted SS/PBCH block index provided by od-ssb-PositionsInBurst in the OD-SSB-Config, the UE does not expect the transmission of SS/PBCH blocks corresponding to the SS/PBCH block index is terminated due to deactivation or adaptation, e.g., until applying an indicated new TCI state, if any, or e.g., when performing the measurement or measurement report or e.g., when performing the measurement or measurement report.

In various embodiments, an OD-SSB for an activated or applied TCI state is provided.

In one embodiment, if a UE is configured with both AO-SSB and OD-SSB in the same cell, and the indicated (e.g., activated) TCI state is at least based on OD-SSB, the UE may apply at least one of the following examples as the TCI state or QCL source, after the transmission of OD-SSB is terminated (e.g., deactivated and/or adapted to be not transmitted).
In one example, the UE can continue to apply the indicated TCI state (e.g., the indicated TCI state is associated with an OD-SSB).
In another example, the UE can apply a default TCI state. For one instance, the default TCI state can be the one with the lowest index. For another instance, the default TCI state can be the one with the highest index. For yet another instance, the default TCI state can be an active TCI state with the lowest index. For yet another instance, the default TCI state can be an active TCI state with the highest index. For yet another instance, the default TCI state can be the one associated with CORESET with the lowest index.
In yet another example, the UE can apply a default QCL assumption, e.g., as the source RS for TCI state. For one instance, the default QCL assumption can be based on an AO-SSB, e.g., used for synchronization of the cell.
In yet another example, the UE can apply the TCI state used or indicated before the indicated TCI state, e.g., the TCI state is associated with an AO-SSB, and/or the TCI state is an activated TCI state.
In yet another example, the UE can select and apply a TCI state, e.g., the TCI state is associated with an AO-SSB, and/or the TCI state is an activated TCI state.

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of SSB associated with the indicated TCI state (e.g., SSB-index) can be included in the actually transmitted OD-SSB index(es) but not included in the actually transmitted AO-SSB index(es), e.g., SSB-index associated with an indicated TCI state corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).
For yet another instance, the association between the index(es) of SSB and the TCI state can be either in an explicit manner (e.g., SSB-index explicitly included in the TCI state) or in an implicit manner (e.g., the SSB is QCLed with the reference signal included in the TCI state).

For another further example, the UE applying the examples as the TCI state or QCL source until one of the following instances:
For one instance, the UE applying the examples as the TCI state or QCL source until applying an indicated new TCI state (e.g., with an application delay after the indication of the new TCI state), if any.
For another instance, the UE applying the examples as the TCI state or QCL source until applying a next TCI state indication (e.g., with an application delay after the next indication of the TCI state), if any.

For example, for a UE configured with both OD-SSB-Config and absoluteFrequencySSB for a SCell, if a SS/PBCH block index associated with an indicated TCI state corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE can continue to apply the indicated TCI state, when the transmission of SS/PBCH blocks corresponding to the SS/PBCH block index is terminated due to deactivation or adaptation, until applying an indicated new TCI state, if any.

For another example, for a UE configured with OD-SSB-Config and not configured with absoluteFrequencySSB for a SCell, if a SS/PBCH block index associated with an indicated TCI state corresponds to an actually transmitted SS/PBCH block index provided by od-ssb-PositionsInBurst in the OD-SSB-Config, the UE can continue to apply the indicated TCI state, when the transmission of SS/PBCH blocks corresponding to the SS/PBCH block index is terminated due to deactivation or adaptation, until applying an indicated new TCI state, if any.

In another embodiment, if a UE is configured with both AO-SSB and OD-SSB in the same cell, the indicated (e.g., activated) TCI state is at least based on OD-SSB, the UE may not expect that the index(es) of SSB associated with the indicated TCI state (e.g., SSB-index) can be included in the actually transmitted OD-SSB index(es) but not included in the actually transmitted AO-SSB index(es), e.g., SSB-index associated with an indicated TCI state corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.

For one further example, the index(es) for actually transmitted OD-SSB provided by each od-ssb-PositionsInBurst in the OD-SSB-Config is same as or a subset of the index(es) for actually transmitted AO-SSB provided by ssb-PositionsInBurst associated with the absoluteFrequencySSB.

In yet another embodiment, if a UE is configured with both AO-SSB and OD-SSB in the same cell, the indicated (e.g., activated) TCI state is at least based on OD-SSB, and the index(es) of SSB associated with the indicated TCI state (e.g., SSB-index) can be included in the actually transmitted OD-SSB index(es) but not included in the actually transmitted AO-SSB index(es), e.g., SSB-index associated with an indicated TCI state corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, then at least one of the following UE behavior can apply:
In one example, the UE does not expect the transmission of OD-SSB to be terminated (e.g., deactivated and/or adapted to be not transmitted) when applying the indicated (e.g., activated) TCI state, e.g., at least for the transmission of OD-SSB corresponding to the indexes not included in the index(es) of AO-SSB.
In another example, the UE does not expect the transmission of OD-SSB to be terminated (e.g., deactivated and/or adapted to be not transmitted) when applying the indicated (e.g., activated) TCI state, e.g., at least for the transmission of OD-SSB corresponding to the indexes not included in the index(es) of AO-SSB and/or when the cell is active.
In yet another example, the UE does not expect the transmission of OD-SSB to be terminated (e.g., deactivated and/or adapted to be not transmitted) before applying an indication of a different TCI state (e.g., the different TCI state corresponds to an SSB index not terminated).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of SSB associated with the indicated TCI state (e.g., SSB-index) can be included in the actually transmitted OD-SSB index(es) but not included in the actually transmitted AO-SSB index(es), e.g., SSB-index associated with an indicated TCI state corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).
For yet another instance, the association between the index(es) of SSB and the TCI state can be either in an explicit manner (e.g., SSB-index explicitly included in the TCI state) or in an implicit manner (e.g., the SSB is QCLed with the reference signal included in the TCI state).

For one example, for a UE configured with both OD-SSB-Config and absoluteFrequencySSB for a SCell, if a SS/PBCH block index associated with an indicated TCI state corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE does not expect the transmission of SS/PBCH blocks corresponding to the SS/PBCH block index is terminated due to deactivation or adaptation, when applying the indicated TCI state, e.g., until applying an indicated new TCI state, if any, and/or when the SCell is activated.

For another example, for a UE configured with OD-SSB-Config and not configured with absoluteFrequencySSB for a SCell, if a SS/PBCH block index associated with an indicated TCI state corresponds to an actually transmitted SS/PBCH block index provided by od-ssb-PositionsInBurst in the OD-SSB-Config, the UE does not expect the transmission of SS/PBCH blocks corresponding to a SS/PBCH block index is terminated (e.g., due to deactivation or adaptation), when applying the indicated TCI state, e.g., until applying an indicated new TCI state, if any, and/or when the SCell is activated.

In various embodiments, an OD-SSB for uplink power control is provided.

In one embodiment, if a UE is configured with both AO-SSB and OD-SSB in the same cell, and the UE is configured to perform uplink power control at least based on OD-SSB (e.g., for downlink pathloss calculation), the UE may stop performing uplink power control based on OD-SSB after the transmission of OD-SSB is terminated (e.g., deactivated and/or adapted to be not transmitted).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for uplink power control (e.g., SSB-index) can be not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).

For yet another further example, if the example instances are not satisfied, the UE may perform uplink power control based on either AO-SSB or OD-SSB (e.g., OD-SSB corresponding to other index(es) which are not terminated) or both AO-SSB and OD-SSB (e.g., OD-SSB corresponding to other index(es) which are not terminated), based on its implementation.

For example, for a UE configured with both od-ssb-absoluteFrequency in OD-SSB-Config and absoluteFrequencySSB for a SCell, if a SS/PBCH block index associated with a configuration for uplink power control corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE can stop perform the uplink power control, when the transmission of SS/PBCH blocks corresponding to the SS/PBCH block index is terminated due to deactivation or adaptation, until applying an indicated new TCI state, if any.

For another example, for a UE configured with OD-SSB-Config and not configured with absoluteFrequencySSB for a SCell, if a SS/PBCH block index associated with a configuration for uplink power control corresponds to an actually transmitted SS/PBCH block index provided by od-ssb-PositionsInBurst in the OD-SSB-Config, the UE can stop perform the uplink power control, when the transmission of SS/PBCH blocks corresponding to the SS/PBCH block index is terminated due to deactivation or adaptation, until applying an indicated new TCI state, if any.

In another embodiment, if a UE is configured with both AO-SSB and OD-SSB in the same cell, and the UE is configured to perform uplink power control at least based on OD-SSB (e.g., for downlink pathloss calculation), the UE may not expect that the index(es) of OD-SSB configured for uplink power control (e.g., SSB-index) is not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.

For one further example, the index(es) for actually transmitted OD-SSB provided by each od-ssb-PositionsInBurst in the OD-SSB-Config is same as or a subset of the index(es) for actually transmitted AO-SSB provided by ssb-PositionsInBurst associated with the absoluteFrequencySSB.

In yet another embodiment, if a UE is configured with both AO-SSB and OD-SSB in the same cell, and the UE is configured to perform uplink power control at least based on OD-SSB (e.g., for downlink pathloss calculation), and the index(es) of OD-SSB configured for uplink power control (e.g., SSB-index) is not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, then at least one of the following UE behavior can apply:
In one example, the UE does not expect the transmission of OD-SSB to be terminated (e.g., deactivated and/or adapted to be not transmitted), e.g., at least for the indexes not included in the index(es) of AO-SSB.
In another example, the UE does not expect the transmission of OD-SSB to be terminated (e.g., deactivated and/or adapted to be not transmitted), e.g., at least for the indexes not included in the index(es) of AO-SSB and/or when the cell is active.
In yet another example, the UE does not expect the transmission of OD-SSB to be terminated (e.g., deactivated and/or adapted to be not transmitted) before applying an indication of a different TCI state (e.g., the different TCI state corresponds to an SSB index not terminated).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for uplink power control (e.g., SSB-index) can be not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).

For example, for a UE configured with both od-ssb-absoluteFrequency in OD-SSB-Config and absoluteFrequencySSB for a SCell, if a SS/PBCH block index associated with a configuration for uplink power control corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE does not expect the transmission of SS/PBCH blocks corresponding to the SS/PBCH block index is terminated due to deactivation or adaptation, e.g., until applying an indicated new TCI state, if any, or e.g., when performing the uplink power control.

For another example, for a UE configured with OD-SSB-Config and not configured with absoluteFrequencySSB for a SCell, if a SS/PBCH block index associated with a configuration for uplink power control corresponds to an actually transmitted SS/PBCH block index provided by od-ssb-PositionsInBurst in the OD-SSB-Config, the UE does not expect the transmission of SS/PBCH blocks corresponding to the SS/PBCH block index is terminated due to deactivation or adaptation, e.g., until applying an indicated new TCI state, if any, or e.g., when performing the measurement or measurement report or e.g., when performing the uplink power control.

In various embodiments, an OD-SSB for radio link monitoring is provided.

In one embodiment, if a UE is configured with both AO-SSB and OD-SSB in the same cell, and the UE is configured to perform radio link monitoring at least based on OD-SSB, the UE may stop performing radio link monitoring based on OD-SSB after the transmission of OD-SSB is terminated (e.g., deactivated and/or adapted to be not transmitted).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for radio link monitoring (e.g., SSB-index) can be not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).

In various embodiments, an OD-SSB for uplink power control is provided.

For yet another further example, if the example instances are not satisfied, the UE may perform radio link monitoring based on either AO-SSB or OD-SSB (e.g., OD-SSB corresponding to other index(es) which are not terminated) or both AO-SSB and OD-SSB (e.g., OD-SSB corresponding to other index(es) which are not terminated), based on its implementation.

For example, for a UE configured with both od-ssb-absoluteFrequency in OD-SSB-Config and absoluteFrequencySSB for a SCell, if a SS/PBCH block index associated with a configuration for radio link monitoring corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE can stop perform the radio link monitoring, when the transmission of SS/PBCH blocks corresponding to the SS/PBCH block index is terminated due to deactivation or adaptation, until applying an indicated new TCI state, if any.

For another example, for a UE configured with OD-SSB-Config and not configured with absoluteFrequencySSB for a SCell, if a SS/PBCH block index associated with a configuration for radio link monitoring corresponds to an actually transmitted SS/PBCH block index provided by od-ssb-PositionsInBurst in the OD-SSB-Config, the UE can stop perform the radio link monitoring, when the transmission of SS/PBCH blocks corresponding to the SS/PBCH block index is terminated due to deactivation or adaptation, until applying an indicated new TCI state, if any.

In another embodiment, if a UE is configured with both AO-SSB and OD-SSB in the same cell, and the UE is configured to perform radio link monitoring at least based on OD-SSB, the UE may not expect that the index(es) of OD-SSB configured for radio link monitoring (e.g., SSB-index) is not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.

For one further example, the index(es) for actually transmitted OD-SSB provided by each od-ssb-PositionsInBurst in the OD-SSB-Config is same as or a subset of the index(es) for actually transmitted AO-SSB provided by ssb-PositionsInBurst associated with the absoluteFrequencySSB.

In yet another embodiment, if a UE is configured with both AO-SSB and OD-SSB in the same cell, and the UE is configured to perform radio link monitoring at least based on OD-SSB, and the index(es) of OD-SSB configured for radio link monitoring (e.g., SSB-index) is not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, then at least one of the following UE behavior can apply:
In one example, the UE does not expect the transmission of OD-SSB to be terminated (e.g., deactivated and/or adapted to be not transmitted), e.g., at least for the indexes not included in the index(es) of AO-SSB.
In another example, the UE does not expect the transmission of OD-SSB to be terminated (e.g., deactivated and/or adapted to be not transmitted), e.g., at least for the indexes not included in the index(es) of AO-SSB and/or when the cell is active.
In yet another example, the UE does not expect the transmission of OD-SSB to be terminated (e.g., deactivated and/or adapted to be not transmitted) before applying an indication of a different TCI state (e.g., the different TCI state corresponds to an SSB index not terminated).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for radio link monitoring (e.g., SSB-index) can be not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).

For example, for a UE configured with both od-ssb-absoluteFrequency in OD-SSB-Config and absoluteFrequencySSB for a SCell, if a SS/PBCH block index associated with a configuration for radio link monitoring corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE does not expect the transmission of SS/PBCH blocks corresponding to the SS/PBCH block index is terminated due to deactivation or adaptation, e.g., until applying an indicated new TCI state, if any, or e.g., when performing the radio link monitoring.

For another example, for a UE configured with OD-SSB-Config and not configured with absoluteFrequencySSB for a SCell, if a SS/PBCH block index associated with a configuration for radio link monitoring corresponds to an actually transmitted SS/PBCH block index provided by od-ssb-PositionsInBurst in the OD-SSB-Config, the UE does not expect the transmission of SS/PBCH blocks corresponding to the SS/PBCH block index is terminated due to deactivation or adaptation, e.g., until applying an indicated new TCI state, if any, or e.g., when performing the measurement or measurement report or e.g., when performing the radio link monitoring.

In various embodiments, an OD-SSB for link recovery procedure is provided.

In one embodiment, if a UE is configured with both AO-SSB and OD-SSB in the same cell, and the UE is configured to perform radio link recovery at least based on OD-SSB, the UE may stop performing radio link recovery based on OD-SSB after the transmission of OD-SSB is terminated (e.g., deactivated and/or adapted to be not transmitted).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for radio link recovery (e.g., SSB-index) can be not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).

For another further example, the UE may start to perform radio link recovery based on another RS.
For one instance, the RS can be selected by the UE as an AO-SSB.

For yet another further example, if the example instances are not satisfied, the UE may perform radio link recovery based on either AO-SSB or OD-SSB (e.g., OD-SSB corresponding to other index(es) which are not terminated) or both AO-SSB and OD-SSB (e.g., OD-SSB corresponding to other index(es) which are not terminated), based on its implementation.

For example, for a UE configured with both od-ssb-absoluteFrequency in OD-SSB-Config and absoluteFrequencySSB for a SCell, if a SS/PBCH block index associated with a configuration for radio link recovery corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE can stop perform the radio link recovery, when the transmission of SS/PBCH blocks corresponding to the SS/PBCH block index is terminated due to deactivation or adaptation, until applying an indicated new TCI state, if any.

For another example, for a UE configured with OD-SSB-Config and not configured with absoluteFrequencySSB for a SCell, if a SS/PBCH block index associated with a configuration for radio link recovery corresponds to an actually transmitted SS/PBCH block index provided by od-ssb-PositionsInBurst in the OD-SSB-Config, the UE can stop perform the radio link recovery, when the transmission of SS/PBCH blocks corresponding to the SS/PBCH block index is terminated due to deactivation or adaptation, until applying an indicated new TCI state, if any.

In another embodiment, if a UE is configured with both AO-SSB and OD-SSB in the same cell, and the UE is configured to perform radio link recovery at least based on OD-SSB, the UE may not expect that the index(es) of OD-SSB configured for radio link recovery (e.g., SSB-index) is not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.

For one further example, the index(es) for actually transmitted OD-SSB provided by each od-ssb-PositionsInBurst in the OD-SSB-Config is same as or a subset of the index(es) for actually transmitted AO-SSB provided by ssb-PositionsInBurst associated with the absoluteFrequencySSB.

In yet another embodiment, if a UE is configured with both AO-SSB and OD-SSB in the same cell, and the UE is configured to perform radio link recovery at least based on OD-SSB, and the index(es) of OD-SSB configured for radio link recovery (e.g., SSB-index) is not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, then at least one of the following UE behavior can apply:
In one example, the UE does not expect the transmission of OD-SSB to be terminated (e.g., deactivated and/or adapted to be not transmitted), e.g., at least for the indexes not included in the index(es) of AO-SSB.
In another example, the UE does not expect the transmission of OD-SSB to be terminated (e.g., deactivated and/or adapted to be not transmitted), e.g., at least for the indexes not included in the index(es) of AO-SSB and/or when the cell is active.
In yet another example, the UE does not expect the transmission of OD-SSB to be terminated (e.g., deactivated and/or adapted to be not transmitted) before applying an indication of a different TCI state (e.g., the different TCI state corresponds to an SSB index not terminated).

For one further example, the embodiment is applicable when at least one of the following instances is satisfied.
For one instance, the UE is provided with a configuration of a frequency location of AO-SSB on the cell, e.g., provided with a higher layer parameter absoluteFrequencySSB.
For another instance, the UE is provided with a configuration of OD-SSB on the cell, e.g., provided with a higher layer parameter OD-SSB-Config.
For yet another instance, the index(es) of OD-SSB configured for radio link monitoring (e.g., SSB-index) can be not included in the index(es) of transmitted AO-SSB, e.g., the index(es) corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB.
For yet another instance, the frequency location of AO-SSB (e.g., provided by absoluteFrequencySSB) is different from the frequency location of OD-SSB (e.g., provided by od-ssb-absoluteFrequency in OD-SSB-Config).
For yet another instance, the terminated transmission of OD-SSB corresponds to the index(es) of the actually transmitted OD-SSB index(es).

For example, for a UE configured with both od-ssb-absoluteFrequency in OD-SSB-Config and absoluteFrequencySSB for a SCell, if a SS/PBCH block index associated with a configuration for radio link recovery corresponds to an actually transmitted SS/PBCH block index provided by od-ssb-PositionsInBurst in the OD-SSB-Config but not corresponds to an actually transmitted SS/PBCH block index provided by ssb-PositionsInBurst associated with the absoluteFrequencySSB, the UE does not expect the transmission of SS/PBCH blocks corresponding to the SS/PBCH block index is terminated due to deactivation or adaptation, e.g., until applying an indicated new TCI state, if any, or e.g., when performing the radio link recovery.

For another example, for a UE configured with OD-SSB-Config and not configured with absoluteFrequencySSB for a SCell, if a SS/PBCH block index associated with a configuration for radio link recovery corresponds to an actually transmitted SS/PBCH block index provided by od-ssb-PositionsInBurst in the OD-SSB-Config, the UE does not expect the transmission of SS/PBCH blocks corresponding to the SS/PBCH block index is terminated due to deactivation or adaptation, e.g., until applying an indicated new TCI state, if any, or e.g., when performing the measurement or measurement report or e.g., when performing the radio link recovery.

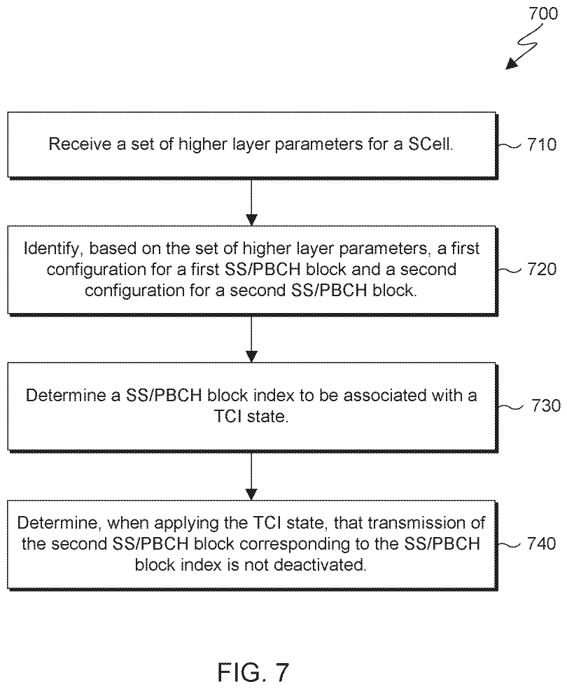

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving a set of higher layer parameters for a SCell (710). The UE then identifies, based on the set of higher layer parameters, a first configuration for a first SS/PBCH block and a second configuration for a second SS/PBCH block (720). For example, in 720, the first configuration includes a first frequency location for the first SS/PBCH block and a first indication of a first set of actually transmitted SS/PBCH block indexes for the first SS/PBCH block. The second configuration includes a second frequency location for the second SS/PBCH block and a second indication of a second set of actually transmitted SS/PBCH block indexes for the second SS/PBCH block. In various embodiments, the SS/PBCH block index is included in the second set of actually transmitted SS/PBCH block indexes and not included in the first set of actually transmitted SS/PBCH block indexes. In various embodiments, the first frequency location is different from the second frequency location.

The UE then determines a SS/PBCH block index to be associated with a TCI state (730). In various embodiments, the SS/PBCH block index is based on an index for a SS/PBCH block included in the TCI state or QCLed with a reference signal included in the TCI state. The UE then determines, when applying the TCI state, that transmission of the second SS/PBCH block corresponding to the SS/PBCH block index is not deactivated (740). In various embodiments, the UE determines to perform an uplink power control based on the second SS/PBCH block corresponding to the SS/PBCH block index and determines, when performing the uplink power control, that a transmission of the second SS/PBCH block corresponding to the SS/PBCH block index is not deactivated. In various embodiments, the uplink power control is for a PUCCH, a PUSCH, a SRS, or a PRACH. In various embodiments, the second SS/PBCH block is an on-demand SS/PBCH block.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

1. A user equipment (UE) in a wireless communication system, the UE comprising:
a transceiver configured to receive a set of higher layer parameters for a secondary cell (SCell); and
a processor operably coupled to the transceiver, the processor configured to:
identify, based on the set of higher layer parameters:
a first configuration for a first synchronization signal and physical broadcast channel (SS/PBCH) block, the first configuration including:
a first frequency location for the first SS/PBCH block, and
a first indication of a first set of actually transmitted SS/PBCH block indexes for the first SS/PBCH block, and
a second configuration for a second SS/PBCH block, the second configuration including:
a second frequency location for the second SS/PBCH block; and
a second indication of a second set of actually transmitted SS/PBCH block indexes for the second SS/PBCH block;
determine a SS/PBCH block index to be associated with a transmission control information (TCI) state; and
determine, when applying the TCI state, that transmission of the second SS/PBCH block corresponding to the SS/PBCH block index is not deactivated.

2. The UE of claim 1, wherein the SS/PBCH block index is included in the second set of actually transmitted SS/PBCH block indexes and not included in the first set of actually transmitted SS/PBCH block indexes.

3. The UE of claim 1, wherein the first frequency location is different from the second frequency location.

4. The UE of claim 1, wherein the SS/PBCH block index is:
based on an index for a SS/PBCH block included in the TCI state, or
quasi-co-located (QCLed) with a reference signal included in the TCI state.

5. The UE of claim 1, wherein the processor is further configured to:
determine to perform an uplink power control based on the second SS/PBCH block corresponding to the SS/PBCH block index; and
determine, when performing the uplink power control, that a transmission of the second SS/PBCH block corresponding to the SS/PBCH block index is not deactivated.

6. The UE of claim 5, wherein the uplink power control is for a physical uplink control channel (PUCCH), a physical uplink shared channel (PUSCH), a sounding reference signal (SRS), or a physical random access channel (PRACH).

7. The UE of claim 1, wherein the second SS/PBCH block is an on-demand SS/PBCH block.

8. A method of a user equipment (UE) in a wireless communication system, the method comprising:
receiving a set of higher layer parameters for a secondary cell (SCell);
identifying, based on the set of higher layer parameters:
a first configuration for a first synchronization signal and physical broadcast channel (SS/PBCH) block, the first configuration including:
a first frequency location for the first SS/PBCH block, and
a first indication of a first set of actually transmitted SS/PBCH block indexes for the first SS/PBCH block, and
a second configuration for a second SS/PBCH block, the second configuration including:
a second frequency location for the second SS/PBCH block, and
a second indication of a second set of actually transmitted SS/PBCH block indexes for the second SS/PBCH block;
determining a SS/PBCH block index to be associated with a transmission control information (TCI) state; and
determining, when applying the TCI state, that transmission of the second SS/PBCH block corresponding to the SS/PBCH block index is not deactivated.

9. The method of claim 8, wherein the SS/PBCH block index is included in the second set of actually transmitted SS/PBCH block indexes and not included in the first set of actually transmitted SS/PBCH block indexes.

10. The method of claim 8, wherein the first frequency location is different from the second frequency location.

11. The method of claim 8, wherein the SS/PBCH block index is:
based on an index for a SS/PBCH block included in the TCI state, or
quasi-co-located (QCLed) with a reference signal included in the TCI state.

12. The method of claim 8, further comprising:
determining to perform an uplink power control based on the second SS/PBCH block corresponding to the SS/PBCH block index; and
determining, when performing the uplink power control, that a transmission of the second SS/PBCH block corresponding to the SS/PBCH block index is not deactivated.

13. The method of claim 12, wherein the uplink power control is for a physical uplink control channel (PUCCH), a physical uplink shared channel (PUSCH), a sounding reference signal (SRS), or a physical random access channel (PRACH).

14. The method of claim 8, wherein the second SS/PBCH block is an on-demand SS/PBCH block.

15. A base station (BS) in a wireless communication system, the BS comprising:
a processor configured to:
determine a first configuration for a first synchronization signal and physical broadcast channel (SS/PBCH) block, the first configuration including:
a first frequency location for the first SS/PBCH block, and
a first indication of a first set of actually transmitted SS/PBCH block indexes for the first SS/PBCH block, and
determine a second configuration for a second SS/PBCH block, the second configuration including:
a second frequency location for the second SS/PBCH block, and
a second indication of a second set of actually transmitted SS/PBCH block indexes for the second SS/PBCH block; and
a transceiver operably coupled to the processor, the transceiver configured to transmit, to a user equipment (UE), a set of higher layer parameters for a secondary cell (SCell), the set of higher layer parameters including the first configuration and the second configuration,
wherein the processor is further configured to:
determine a SS/PBCH block index to be associated with a transmission control information (TCI) state; and
determine, when applying the TCI state, that transmission of the second SS/PBCH block corresponding to the SS/PBCH block index is not deactivated.

16. The BS of claim 15, wherein the SS/PBCH block index is included in the second set of actually transmitted SS/PBCH block indexes and not included in the first set of actually transmitted SS/PBCH block indexes.

17. The BS of claim 15, wherein the first frequency location is different from the second frequency location.

18. The BS of claim 15, wherein the SS/PBCH block index is:
based on an index for a SS/PBCH block included in the TCI state, or
quasi-co-located (QCLed) with a reference signal included in the TCI state.

19. The BS of claim 15, wherein:
the processor is further configured to:
determine that the UE performs an uplink power control based on the second SS/PBCH block, corresponding to the SS/PBCH block index; and
determine that a transmission of the second SS/PBCH block corresponding to the SS/PBCH block index is not deactivated, when the UE performs the uplink power control, and
the uplink power control is for a physical uplink control channel (PUCCH), a physical uplink shared channel (PUSCH), a sounding reference signal (SRS), or a physical random access channel (PRACH).

20. The BS of claim 15, wherein the second SS/PBCH block is an on-demand SS/PBCH block.
